(19) United States
(12) Patent Application Publication
(10) Pub. No.: US 2010/0269973 A1
(43) Pub. Date: Oct. 28, 2010

(54) MASONRY PIECE AND METHOD OF FABRICATION

(76) Inventor: Manuel MEDEIROS, Laval (CA)

Correspondence Address: GOUDREAU GAGE DUBUC, 2000 MCGILL COLLEGE, SUITE 2200, MONTREAL, QC, H3A 3H3, CA

(21) Appl. No.: 12/727,480

(22) Filed: Mar. 19, 2010

Related U.S. Application Data
(60) Provisional application No. 61/161,453, filed on Mar. 19, 2009.

(51) Int. Cl. E04F 13/21; C04B 28/14; B29C 39/12

(52) U.S. Cl. 156/71; 106/782; 264/299

(57) ABSTRACT

A method for manufacturing an artificial masonry piece includes admixing one portion of vermiculite, by volume, with at least three and less than five portions of calcium sulfate (CaSO4) in solution to form a mixture; and curing said mixture.

### CROSS-REFERENCE TO RELATED APPLICATIONS

This application claims benefit, under 35 U.S.C. § 119(e), of U.S. provisional application Ser. No. 61/161,453, filed on Mar. 19, 2009.

### FIELD OF THE INVENTION

The present invention relates to a masonry piece and method of fabrication. More particularly, this invention relates to interior wall veneers that simulate bricks or natural stones.

### BACKGROUND OF THE INVENTION

Wall products for interiors, finished to simulate the look and feel of wood, brick or stone are commonly used in the construction and finishing trades as a practical and economical alternative to natural finishing products. Such simulated products can be grouped into two categories. A first category consists of molded or printed representations of wood, brick, stone or other material on wall panels, generally in dimensions of 4′×8′. A second category of wall products consists of discretely simulated elements that are adhesively attached to a wall surface.

The prior art classified under the second category of simulated finishing products teaches various methods for fabricating discrete artificial masonry elements and installation thereof on a surface, generally a wall. Patents identified in the prior art can be divided into three categories. The first category includes methods of laying precast or sectional elements on surfaces. For example, U.S. Pat. No. 3,690,076 by Harris and U.S. Pat. No. 4,727,698 by Altman disclose the construction of fireplaces utilizing such elements and methods. As a further example, U.S. Pat. No. 5,535,563 by Brown discloses the installation of fitted manufactured stones to build decorative walls. The second category includes molds to create artificial elements simulating stones and bricks. For example, U.S. Pat. No. 5,637,236 by Lowe discloses a method for producing wall, roadway, and sidewalk elements and the like using cementitous material and molds. The last category includes processes for creating decorative elements. For example, U.S. Pat. No. 4,043,826 by Hum discloses a process for making artificial rock.

Generally, the prior art in the field, which includes prior art systems such as non-cement based products easily adaptable for this duty, has many separate and distinct attributes that are widely known to and commonly used in the industry. These attributes include:
(a) the usage of calcium sulfate and pigments as aggregates for lightweight compounds used to form simulated bricks and stones;
(b) the usage of molds to shape objects made out of the aforementioned compounds;
(c) the ease of assembly and production of simulated bricks and stones elements;
(d) discrete masonry pieces which are easy to cut with precision and easy to install.

These products are designed to provide a handyman in the construction and finishing trades a lightweight, low-cost and easy to install product. However, there is still a need for a masonry type product that provides discrete masonry pieces which are easy to cut with precision and easy to install and contain all of the attributes and elements of the prior art. An artificial piece of masonry, as used according to the combination of inventive concepts and details herein set forth, provides novel concepts of a desirable and usefully advantageous installation and procedure, yielding advantages which are special and particular when used as herein set forth.

What is therefore needed, and one object of the present invention, is a masonry type product that provides lightweight discrete masonry pieces which are easy to cut with precision and easy to install.

### SUMMARY OF THE INVENTION

More specifically, in accordance with the present invention there are provided simple and efficient techniques for forming and installing a lightweight decorative wall panel which is adapted to be fastened to a wall substrate. The artificial masonry piece cutable by scoring with the use of a blunt instrument or a knife comprises a portion of vermiculite admixed, by volume, with four (4) portions of calcium sulfate (CaSO4) in solution. The resulting mixture is stirred and pigments preferably are added thereto. The mixture is then poured into molds for curing. Once cured, said artificial masonry piece being cutable by scoring.

The present invention further provides a method for manufacturing artificial masonry pieces consisting of one portion of vermiculite is admixed, by volume, with four (4) portions of calcium sulfate (CaSO4) in solution and a resulting mixture is stirred. Pigments in the form of metal oxides are preferably added to the mixture. The mixture is then poured into molds and set to cure.

An artificial masonry piece has a curing process done at a temperature set at between 12 degrees Celsius and 25 degrees Celsius, cured at 17 relative humidity with a duration is four (4) hours. Air bubbles are extracted from the resulting mixture after stirring is completed.

The present invention further provides a method for making artificial masonry pieces consisting of one portion of vermiculite admixed, by volume, with four (4) portions of calcium sulfate (CaSO4) in solution. The resulting mixture is stirred at a speed, of a ranged set between 60-100 RPM where the stirring taking between eight (8) to 12 minutes. Once stirring is completed, air bubbles are preferably extracted from the mixture. Pigments in the form of metal oxides are preferably added to the mixture which is then poured into molds and set to cure. This curing process is done at a temperature set between 12 degrees Celsius to 25 degrees Celsius at 17% relative humidity and for a duration of four (4) hours.

The present invention further provides for a method of installing artificial masonry pieces resulting from the method of fabrication as described above by using an adhesive or bonding agent applied onto a surface and then applying the whole masonry pieces or masonry pieces that have been cut by making a score line with a cutting means on its surface and cracking the piece along this score line. Joints are then filled with mortar as is normally done for ordinary brick or stone constructions.

Other objects, advantages and features of the present invention will become more apparent upon reading of the following non-restrictive description of specific embodiments thereof, given by way of example only with reference to the accompanying drawings.

### DETAILED DESCRIPTION OF THE ILLUSTRATIVE EMBODIMENTS

The present invention as described herein has advantages in both concept and in component parts and features over the prior art. Such features and advantages include an artificial masonry piece cutable by scoring, a method for manufacturing artificial masonry pieces, a method for installing discrete masonry pieces, and a lightweight non-cementitious artificial masonry piece for use as a decorative covering.

In order to arrive with the above stated features and advantages, the invention generally comprises an artificial masonry piece consisting of admixing as a favoured ratio one (1) portion of vermiculite (used as a filler), by volume, with four (4) portions of calcium sulfate (CaSO4), also known as gypsum, in solution (used as a binder). Preferably, lightweight expanded aggregate or vermiculate glaze is used as the filler. Indeed, as known in the art, in its expanded form, vermiculite has a low density and thermal conductivity, which makes it attractive for use as a soil amendment, lightweight construction aggregate, and thermal insulation filler. The calcium sulfate in solution is readily available in an optimally premixed commercial form to facilitate the manufacturing process. Once admixed, the compound is stirred at low speed, approximately 60-100 Rotations Per Minute (RPM) for a duration between eight (8) and 12, preferably ten (10), minutes. During stirring, various pigments are preferably illustratively added, generally metal oxides, in quality and quantity dependent upon the final color desired.

Once the stirring is completed, the compound is illustratively put into a vacuum chamber to remove air bubbles trapped within the mixture. The mixture is then removed from the vacuum chamber and poured into molds where it will cure. The preferred curing process is done at a temperature set between 12 degrees Celsius and 25 degrees Celsius, preferably at 17% relative humidity for a period of approximately four (4) hours.

Since the masonry pieces are mostly made out of calcium sulfate and are lightweight, many types of adhesives, including a standard type 1 tile adhesive, can be used to cover the surface upon which one desires to install the masonry pieces. Advantageously, the ratio of vermiculite to gypsum used in the present invention alleviates the need for a wire mesh prior to the application of the adhesive. The masonry pieces are then applied to the wall covered with adhesive. Also, the masonry pieces of the present invention offer the added advantage of being easily cut, thus enabling the shape of a piece, which is too large relative to the space it is intended to be installed in, to be customized to fit the desired space. This can be illustratively achieved by simply making a score line on the piece with a cutting means, such as a knife, saw, or blunt object such as a screwdriver or key, and then cracking the piece along the score line. Once the masonry pieces are installed on the wall, the gaps therebetween are then filled and bound together with a suitable material, such as mortar, as is conventionally done for brick or stone constructions. The masonry pieces can therefore be used in drywall as bricks, stones, door contours, and other panels in a variety of applications, such as decorative finishings and coverings of interior walls and ceilings. The adhesive can be applied on a variety of materials, such as concrete, cinder blocks, gypsum boards, wood, or melamine, from which a wall substrate is manufactured.

The masonry pieces formed by the process of the present invention are advantageously easier to cut and rivet to a wall surface and have a significantly lower weight than prior art products. Moreover, the ratio of vermiculite to gypsum of the present invention enables to achieve a masonry piece with a good porosity, which for example enables for the masonry piece to result in a more even finish when painted, in addition to allowing control the rugosity of the back surface of the pieces so as to facilitate installation and attachment thereof (using an adhesive or the like) onto a wall surface. Also, the masonry pieces have an improved fire resistance (e.g. inflammable at 1000 degrees) and can resist ultraviolet radiation.

Indeed, experimental results showed that using a higher (e.g. five(5)-to-one(1) or more) ratio, the thus manufactured masonry pieces tend to be too heavy and have a smooth surface, thus proving difficult for use in the above-mentioned applications. Alternatively, using a lower (e.g. one(1)-to-one(1) or two(2)-to-one(1)), the thus manufactured masonry pieces tend to dry less easily and to be very brittle and fragile. Also, it becomes more difficult to spread the masonry pieces on a wall surface. The four(4)-to-one(1) ratio is therefore preferable to achieve the advantageous results discussed herein above.

Although the present invention has been described hereinabove by way of specific embodiments thereof, it can be modified, without departing from the spirit and nature of the subject invention as defined in the appended claims.

1. An artificial masonry piece cutable by scoring with the use of a blunt instrument or a knife and wherein:
a portion of vermiculite is admixed, by volume, with at least three and less than five portions of calcium sulfate (CaSO4) in solution to produce a mixture;
said mixture being stirred;
said mixture being poured into molds for curing; and
once cured, said artificial masonry piece being cutable by scoring.

2. The artificial masonry piece of claim 1, wherein said one portion of vermiculite is admixed with four portions of calcium sulfate (CaSO4) in solution.

3. The artificial masonry piece of claim 1, wherein pigments are added to said mixture.

4. The artificial masonry piece of claim 3, wherein said pigments comprise metal oxides.

5. The artificial masonry piece as in claim 1, wherein a curing process is done at a temperature set at between 12 degrees Celsius and 25 degrees Celsius.

6. The artificial masonry piece as in claim 1, wherein a curing process is done at 17% relative humidity.

7. The artificial masonry piece as in claim 1, wherein a curing duration is 4 hours.

8. The artificial masonry piece as in claim 1, wherein air bubbles are extracted from the resulting mixture after stirring is completed.

9. A method for manufacturing artificial masonry pieces comprising :
admixing one portion of vermiculite, by volume, with at least three and less than five portions of calcium sulfate (CaSO4) in solution to produce a mixture;
stirring said mixture at a predetermined speed;
pouring said mixture into molds; and
setting said mixture to cure.

10. The method of claim 9, wherein said one portion of vermiculite is admixed with four portions of calcium sulfate (CaSO4) in solution.

11. The method of claim 9, further comprising adding pigments to said mixture.

12. The method of claim 11, wherein said pigments comprise metal oxides.

13. The method of claim 9, wherein said speed is between 60 and 100 revolutions per minute (RPM).

14. The method of claim 9, wherein said stirring takes between 8 and 12 minutes.

15. The method of claim 9, wherein said setting to cure is done at a temperature between 12 degrees Celsius to 25 degrees Celsius.

16. The method of claim 9, wherein said setting to cure is done at 17% relative humidity.

17. The method of claim 9, wherein said setting to cure lasts 4 hours.

18. The method of claim 9, further comprising extracting air bubbles from said mixture after said stirring is completed.

19. A method for installing onto a surface an artificial masonry piece resulting from the method of claim 9, comprising:
applying an adhesive or bonding agent onto a surface;
cutting the masonry piece to a desired size adapted to fit the surface,
said cutting comprising:
making a score line using a cutting means;
cracking the masonry piece along said score line; and
applying the masonry piece to the surface.

20. An artificial masonry piece comprising vermiculite.

21. A method for manufacturing an artificial masonry piece comprising :
admixing one portion of vermiculite, by volume, with at least three and less than five portions of calcium sulfate (CaSO4) in solution to form a mixture; and
curing said mixture.
